(19) United States
(12) Patent Application Publication
(10) Pub. No.: US 2025/0173759 A1
(43) Pub. Date: May 29, 2025

(54) PROFIT POOL OPTIMIZATION PROCESS (PPOP)

(71) Applicant: Combined Consultants LLC, Villa Hills, KY (US)

(72) Inventors: C. Gordon Wade, Villa Hills, KY (US); Venkatesh Bala, New York, NY (US)

(21) Appl. No.: 18/955,742

(22) Filed: Nov. 21, 2024

Related U.S. Application Data
(60) Provisional application No. 63/602,538, filed on Nov. 24, 2023.

(51) Int. Cl. G06Q 30/0251

(52) U.S. Cl. CPC G06Q 30/0261

(57) ABSTRACT

A Profit Pool Optimization Process (PPOP) provides retailers or brand owners in the consumer products vertical or any other vertical where retailers/brand owners can capture relevant personalized data and deliver incentives directly to high potential consumers the opportunity to generate significantly more profit. The PPOP can target particularly high potential shoppers via the use of multiple synergistic user-permissioned data sources, sophisticated artificial intelligence algorithms and analytics, relevant cash and non-cash incentives, and advertising messages, and deliver these incentives through a personalized user-permissioned retail media network communication capability or the equivalent thereof.

### CROSS-REFERENCE TO RELATED APPLICATION(S)

This application claims priority under 35 U.S.C. § 119 (e) of the U.S. Provisional Patent Application Ser. No. 63/602,538, filed Nov. 24, 2023 and titled, “PROFIT POOL OPTIMIZATION PROCESS (PPOP),” which is hereby incorporated by reference in its entirety for all purposes.

### FIELD OF THE INVENTION

The present invention relates to artificial intelligence. More specifically, the present invention relates to profit pool optimization using artificial intelligence.

### BACKGROUND OF THE INVENTION

Advertising on a television network or elsewhere involves an advertiser paying to reach a general audience, many of whom have little to no interest in purchasing the goods or services being advertised. For example, an advertisement for infant diapers broadcast to the general population is viewed by people who have no interest in purchasing infant diapers. More specifically, roughly 97% of the people who see the infant diapers advertisement have no interest in purchasing infant diapers.

### SUMMARY OF THE INVENTION

A Profit Pool Optimization Process (PPOP) provides retailers or brand owners in the consumer products vertical or any other vertical where retailers/brand owners can capture relevant personalized data and deliver incentives directly to high potential consumers the opportunity to generate significantly more profit. The PPOP can target particularly high potential shoppers via the use of multiple synergistic user-permissioned data sources, sophisticated artificial intelligence algorithms and analytics, relevant cash and non-cash incentives, and advertising messages, and deliver these incentives through a personalized user-permissioned retail media network communication capability or the equivalent thereof.

In one aspect, a method comprises acquiring general consumer data, acquiring direct consumer data, processing the general consumer data and the direct consumer data using machine learning, providing an advertisement or commercial opportunity to a user device based on the machine learning, determining a geographic location of the user device and updating the advertisement or commercial opportunity on the user device based on the geographic location of the user device. The general consumer data comprises geo-coded information, manufacturer information, and household information. The direct consumer data is acquired from mobile phones and point-of-sale devices. The direct consumer data is anonymized. The machine learning trains using the general consumer data and the direct consumer data. The method further comprises providing analytics and visualizations to optimize retail media network profit pools. Determining the geographic location of the user device includes utilizing near-field communication to communicate with the user device to determine how close to an exit of a store the user device is.

In another aspect, an apparatus comprises a non-transitory memory for storing an application, the application for: acquiring general consumer data, acquiring direct consumer data, processing the general consumer data and the direct consumer data using machine learning, providing an advertisement or commercial opportunity to a user device based on the machine learning, determining a geographic location of the user device and updating the advertisement or commercial opportunity on the user device based on the geographic location of the user device and a processor coupled to the memory, the processor configured for processing the application. The general consumer data comprises geo-coded information, manufacturer information, and household information. The direct consumer data is acquired from mobile phones and point-of-sale devices. The direct consumer data is anonymized. The machine learning trains using the general consumer data and the direct consumer data. The application is further configured for providing analytics and visualizations to optimize retail media network profit pools. Determining the geographic location of the user device includes utilizing near-field communication to communicate with the user device to determine how close to an exit of a store the user device is.

In another aspect, a system comprises one or more servers configured for: receiving general consumer data and direct consumer data and processing the general consumer data and the direct consumer data using machine learning, a mobile device configured for: acquiring direct consumer data and sending the direct consumer data, receiving an advertisement or commercial opportunity based on the machine learning, providing a geographic location to the one or more servers and updating the advertisement or commercial opportunity on the user device based on the geographic location of the mobile device and one or more sensor devices for communicating with the mobile device regarding the geographic location of the mobile device. The general consumer data comprises geo-coded information, manufacturer information, and household information. The direct consumer data is acquired from mobile phones and point-of-sale devices. The direct consumer data is anonymized. The machine learning trains using the general consumer data and the direct consumer data. The one or more servers are further configured for providing analytics and visualizations to optimize retail media network profit pools. Determining the geographic location of the user device includes utilizing near-field communication to communicate with the user device to determine how close to an exit of a store the user device is.

### BRIEF DESCRIPTION OF THE DRAWINGS

FIG. 1 shows the various components and end users of PPOP according to some embodiments.

FIG. 2 shows a diagram of the end-to-end process from data collection and storage to the final analytical product delivered to end-users according to some embodiments.

FIG. 3 shows a block diagram of an exemplary computing device configured to implement the PPOP according to some embodiments.

FIG. 4 shows a diagram of a network of devices implementing the PPOP according to some embodiments.

### DETAILED DESCRIPTION OF THE PREFERRED EMBODIMENT

A Profit Pool Optimization Process (PPOP) provides retailers or brand owners in the consumer products vertical or any other vertical where retailers/brand owners can capture relevant personalized data and deliver incentives directly to high potential consumers the opportunity to generate significantly more profit. The PPOP can target particularly high potential shoppers via the use of multiple synergistic user-permissioned data sources, sophisticated artificial intelligence algorithms and analytics, relevant cash and non-cash incentives, and advertising messages, and deliver these incentives through a personalized user-permissioned retail media network communication capability or the equivalent thereof.

These personalized incentives may then be embedded in user-permissioned target consumer cell phones or other digital devices as well as retailer point of sale devices capable of communication with the PPOP so that the consumer may be rewarded for purchase or informed of an attitudinal enhancement message during a physical trip to the retail location or when ordering remotely for pick up at the store or home delivery.

### Data

The PPOP uses multiple data sources which interact synergistically in the process. These data sources include first party data from retailers or manufacturers regarding individual shopper attitudes and purchase behavior as well as third party data such as household panel data, Nielsen or IRI store census data, NPD panel data, open source U.S. government macroeconomic, demographic and purchase behavior data, retailer and manufacturer incentive response data, retail media network data or any data related to shopper behavior from third party data suppliers that enhance understanding of individual or geo-demographic consumer behavior or potential worth to a retailer or manufacturer.

### AI/ML Driven Identification of High Potential Consumers

The synergistic data sources mentioned above are then accessed from multiple servers and arrayed in an artificial intelligence server platform for the purpose of identifying individual shoppers with the highest potential for incremental sales either to a retailer or brand owner. The software focuses on finding those shoppers at the retailer or within the brand franchise that have previously bought the category or the brand at the retailer but have not purchased a significant amount of their measured annual requirements in the category or for the brand at the retailer in question. These unrealized purchases comprise a valuable incremental profit pool which brands or retailers may exploit using the PPOP described herein.

The high potential shoppers are not personally identified but rather identified by their known numerical identifier in files such as a retailer loyalty card digital file. This ensures that the privacy of the individual shopper is not violated but that the system follows the protocol to which the shopper has agreed (e.g., shopper-permissioned) that her/his behavior may be used for analytical purposes such as that of the PPOP. The analytics may reveal multiple attributes of the individual shopper such as the preferred retail outlet or means of remote digital ordering as well as the preferred incentives of the shopper.

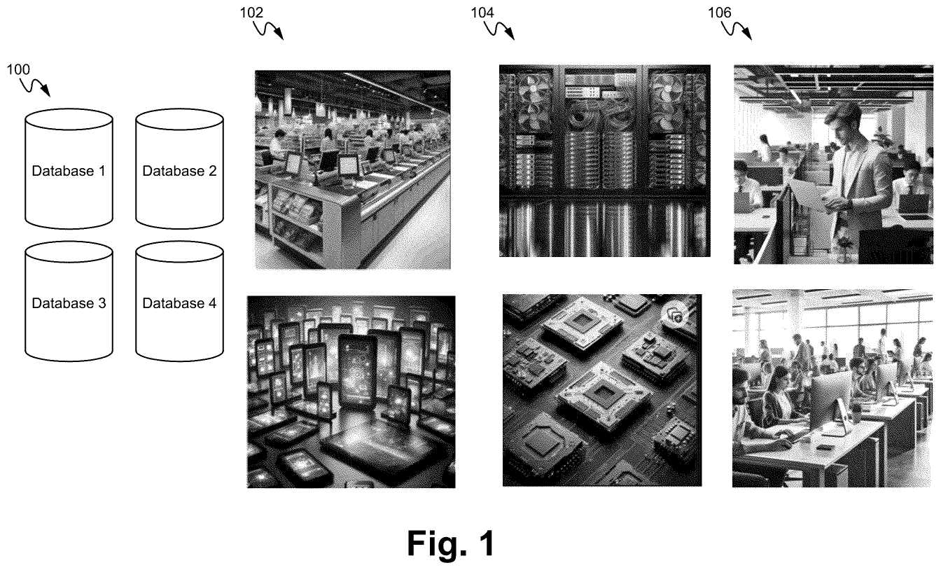

FIG. 1 shows the various components and end users of PPOP according to some embodiments. One or more databases 100 are able to store geo-coded data from federal agencies, open-source data, third-party panel data, and other data. Endpoint devices 102 collect data and/or receive data. The endpoint devices 102 are able to include Point-of-Sale (POS) machines at retailers and mobile phones used by users. Servers 104 with specialized Artificial Intelligence (AI) chips for large scale data optimizations are utilized. End-users 106 of the process include brand managers, marketing analysts, and retail category managers. In some embodiments, end-users 106 include customers.

### Consumer Incentive Development

Once the specific high profit potential shoppers are identified, the retailer or brand that is using PPOP will develop specific incentives based on the learning from the process. These incentives will then be arrayed within an offer conveyed to the specific target shopper via a retail media network server owned or managed by the retailer in question following the protocols well established by these unique networks to communicate with shoppers.

### Retail Media Network Incentive Delivery

Retail media networks (RMNs) are a relatively new development within the commercial landscape. These networks are either owned by the retailer or licensed by the retailer from a third-party provider. They enable the delivery of a wide variety of commercial incentives or advertising materials to shoppers who have agreed to their use. RMNs have enjoyed spectacular growth because they offer multiple advantages to the retailer and brand owners. Specifically, they offer brand owners the opportunity to reach a consumer while planning a retail shopping trip or during the shopper trip itself and via the PPOP system, they are directed only to people who have a demonstrated interest in the category or the brand.

For example, an infant diaper brand would only pay to advertise over an RMN to shoppers who have an infant for whom they care. This contrasts with advertising over a TV network where the advertiser must pay to reach the 97% of households who have no interest in buying infant diapers.

The process offers dramatic increases in analytics to improve the shopping and advertising experience.

### Marketing Efficiency

Another meaningful advantage of RMNs is their ability to offer a closed loop analysis of the efficiency and effectiveness of the marketing expenditure because the marketers have access to the purchase behavior of those to whom the message is directed. This contrasts with virtually all other advertising and marketing means in which the identification of a specific relatively expensive marketing tactic is often difficult to identify given the number of incentives and other activity which occurs simultaneously with the incentive one is trying to measure. In most cases an expenditure on a retail media network facilitates a more accurate measurement of efficiency and effectiveness by enabling access to the actual behavior of those to whom the incentive was directed.

There are a few examples of the metrics that are able to be developed via the process: loyalty levels of retail brands and categories; ROI of specific incentives by brand, by size, by price incentive, by flavor, and more; increases in brand share and the retailer's category share; longer term effect on loyalty my brand, category, and size and for the retailer category effect; brand X's ability to switch product behavior by targeted consumer; and response by key shopper retail behavior retail developed types.

### Incentive Embedment in Consumer Cell or Retail POS Device

As mentioned above, the incentive delivered by the retail media network is sent through third party servers (usually to a cell phone or a retailer's point of sale checkout device) so that the shopper may present the incentive at the time of ordering remotely or purchasing within a bricks and mortar retail location.

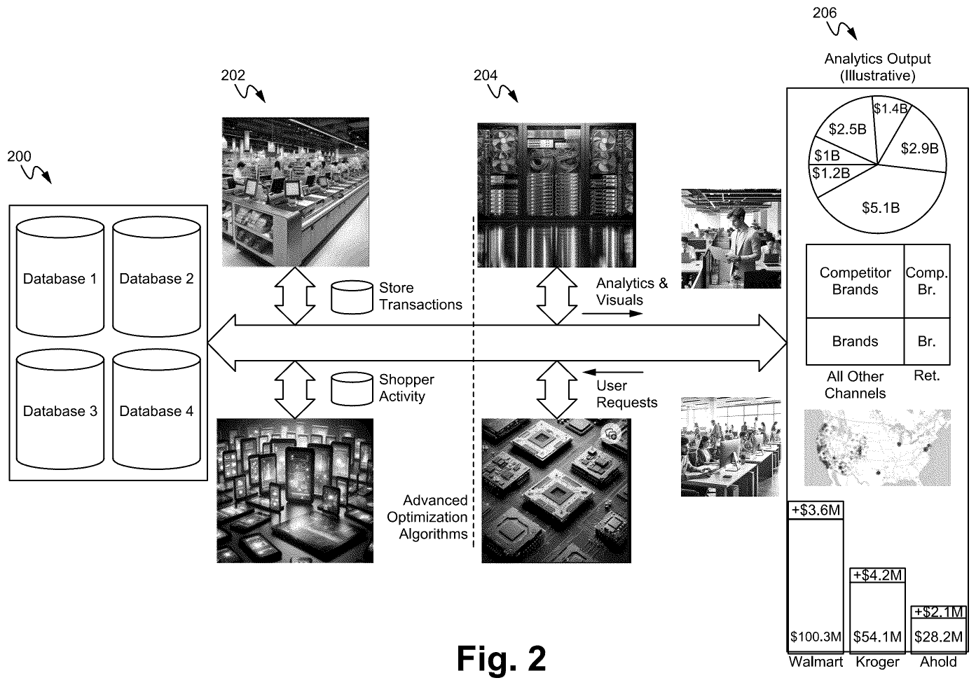

FIG. 2 shows a diagram of the end-to-end process from data collection and storage to the final analytical product delivered to end-users according to some embodiments. In the step 200, data is acquired. For example, the data includes: geo-coded data from federal agencies, manufacturer information from manufacturers, household information from government databases, and/or other information. The data provides a base layer of the PPOP.

In the step 202, direct data is acquired from mobile phones and point-of-sale devices for shopper and profit pool optimization. For example, when users perform searches for items to purchase using their mobile device, or when users purchase items using their mobile device, that information is collected. Also, the point-of-sale device which is used to make the purchase is able to collect the purchase information. Any other device or mechanism is able to be used to collect purchase information. The data is able to be collected in an anonymous or semi-anonymous manner such as by assigning a number or other unique identifier to correspond with a purchaser or account. In some embodiments, the high potential shoppers are not personally identified but rather identified by their known numerical identifier in files such as a retailer loyalty card digital file.

In the step 204, the synergistic data sources mentioned above are then accessed from multiple servers and arrayed in an artificial intelligence server platform for the purpose of identifying individual shoppers with the highest potential for incremental sales either to a retailer or brand owner. The software focuses on finding those shoppers at the retailer or within the brand franchise that have previously bought the category or the brand at the retailer but have not purchased a significant amount of their measured annual requirements in the category or for the brand at the retailer in question. These unrealized purchases comprise a valuable incremental profit pool which brands or retailers may exploit using the PPOP process described herein. The analytics may reveal multiple attributes of the individual shopper such as the preferred retail outlet or means of remote digital ordering as well as the preferred incentives of the shopper.

In the step 206, end-users of the PPOP process receive analytics and visualizations to optimize their RMN profit pools. Analytics and visualizations are able to include text, graphs, charts, maps, and/or any other implementation.

In some embodiments additional steps are implemented. For example, a company or store is able to provide users discounts or other benefits while the users are shopping to encourage further purchases. The users are also able to receive encouragement to purchase items when they are not shopping. For example, if a company knows the user typically purchases a frozen pizza once a month, and the month is almost over, the pizza company is able to send (or cause to send) a coupon for the user to purchase a frozen pizza that expires at the end of that month.

In some embodiments, a user device is tracked and appropriate and timely notices are provided based on the AI analysis. For example, if a user's geographic location is near a store which carries his favorite ice cream, and he has not purchased his monthly half-gallon of ice cream, an advertisement for 10% off is able to be pushed to his device from an advertising server or other cloud device. Any other motivating offer is able to be provided such as a free box of ice cream cones with the purchase of the specific brand of ice cream. In another example, when the user is in the store, his mobile device is able to provide alerts when he is proximate to an item that he has previously purchased or is on his shopping list. Or the mobile device app guides the user to where the item is by displaying an arrow on an in-store map or using augmented reality to show arrows of which way to go in the store.

Additionally, the mobile device is able to communicate with in-store sensors using near-field communication, Bluetooth®, or any other communication mechanism. Based on the communications, the mobile device encourages user purchases. For example, as the user gets closer to the exit of the store, an advertisement is provided for items previously purchased but not purchased this time. Additionally, as the sensors closer to the exit or check out counter detect the user, the advertisement benefit increases. For example, if the user has left the ice cream section without picking up the desired item, a coupon of 10% off is provided to the user, but as time passes or as the user is detected near the check out counter, a new coupon of 20% off is provided on the user's mobile device. Implementations to prevent manipulation of the system are able to be utilized such as only providing an increased coupon on one item per visit.

In some embodiments, the order of the steps are modified.

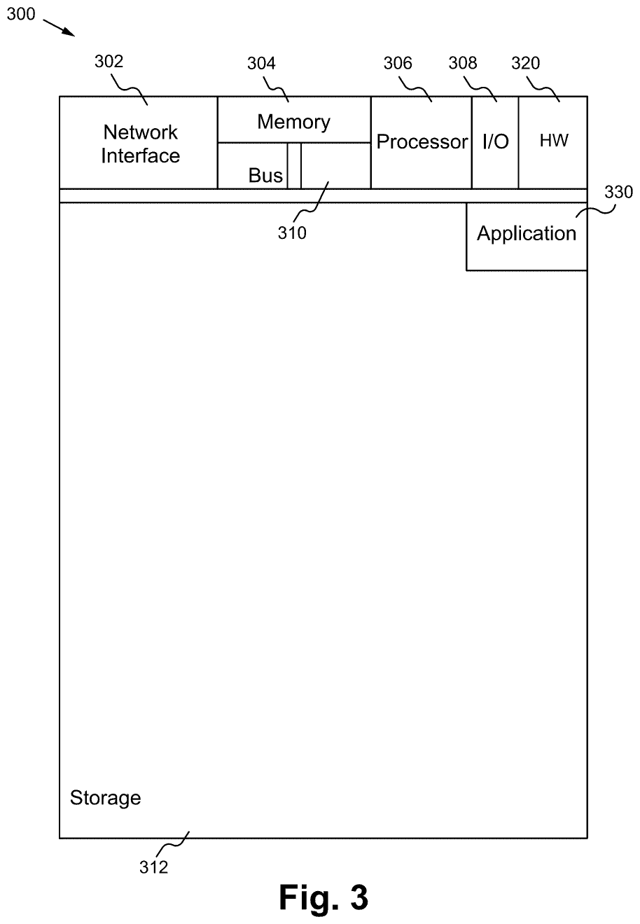

FIG. 3 shows a block diagram of an exemplary computing device configured to implement the PPOP according to some embodiments. The computing device 300 is able to be used to acquire, store, compute, process, communicate and/or display information. The computing device 300 is able to implement any of the PPOP aspects. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, High Definition disc/drive, ultra-HD drive, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, screen, printer, modem, touchscreen, button interface and other devices. PPOP application(s) 330 used to implement the PPOP are likely to be stored in the storage device 312 and memory 304 and processed as applications are typically processed. More or fewer components shown in FIG. 3 are able to be included in the computing device 300. In some embodiments, PPOP hardware 320 is included. Although the computing device 300 in FIG. 3 includes applications 330 and hardware 320 for the PPOP, the PPOP is able to be implemented on a computing device in hardware, firmware, software or any combination thereof. For example, in some embodiments, the PPOP applications 330 are programmed in a memory and executed using a processor. In another example, in some embodiments, the PPOP hardware 320 is programmed hardware logic including gates specifically designed to implement the PPOP.

In some embodiments, the PPOP application(s) 330 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

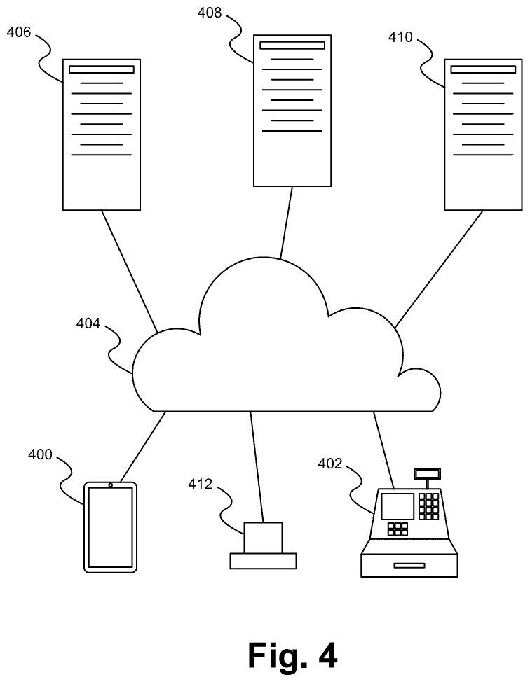

FIG. 4 illustrates a diagram of a network of devices implementing the PPOP according to some embodiments. The network of devices includes mobile devices 400, point-of-sale devices 402, a network 404, AI servers 406, government servers 408, merchant servers 410 and sensor devices 412.

The mobile devices 400 are used to send and receive information. For example, purchase information from the mobile devices 400 is able to be continuously received and tracked by the AI server 406 or another server. Additional information is able to be communicated from the mobile devices 402 such as current geographical location information. The mobile devices 400 receive coupons, advertisements and/or other information.

The point-of-sale devices 402 send information to the AI server 406 or another server to be analyzed. The point-of-sale devices 402 are able to receive information as well.

The AI servers 406 use machine learning to analyze purchase information, merchant information, user information, and/or any other information to determine how to encourage additional consumerism by users. For example, the AI servers 406 determine trends and/or purchasing behavior to then provide coupons, advertisements and/or other communications to users, merchants, advertisers or other businesses. The AI servers 406 are able to acquire other information such as location information which is able to be analyzed and used in communicating location-specific advertising or other data.

The government servers 408 are able to provide information to the AI servers 406 such as household income, household size, and/or any other relevant information that is able to be utilized to analyze users (e.g., purchasers) to provide advertising and/or purchasing incentives.

The merchant servers 410 are able to provide information to the AI servers 406 such as sales information, specific user purchase information, product information, advertising information/content, and/or any other merchant information that is able to be utilized to analyze users (e.g., purchasers) to provide advertising and/or purchasing incentives.

Sensor devices 412 are able to be used in stores such as a grocery store to determine the location of the user. In some embodiments, the sensor devices 412 are included with or within the point-of-sale devices 402. The sensor devices 412 are able to be any type of sensor device such as a device which uses near-field communication or another wireless communication technology to communicate with a user's mobile device, and then send a communication through the network 404 to the AI server 406 or another server, which then communicates an advertisement or offering to the mobile device.

The network 404 is able to include any network such as the Internet, local area networks, cellular networks, wireless networks, wired networks, satellite networks and others.

Any of the devices described herein include a storage component including one or more databases or data structures to store any of the information described herein.

To utilize the PPOP described herein, companies such as merchants receive AI-driven information which enables the companies to provide advertisements or benefits to consumers to encourage the consumers to purchase goods and services from the company. Users such as consumers receive promotions, advertisements and other information from companies to increase their ability or desire to purchase goods and services.

In operation, the PPOP utilizes AI to analyze a wide range of data, including specific user information, to provide various advertising and/or benefits to consumers so that the consumers are further encouraged to purchase items. Additionally, although targeted advertising has been implemented previously based on searches or other data, there are technical limitations with this type of targeting. By utilizing geolocation data, companies are able to overcome the technical limitations of search-based targeting, and users are able to be further encouraged to make purchases, which increases the likelihood of an actual purchase. The geolocation implementation is able to utilize sensors in the store and other mechanisms to determine the current location of the user with respect to locations to purchase items or the locations of the items themselves.

The PPOP is a coordinated, cohesive process, where each step receives a specific input (e.g., from a prior step) and produces a specific output (e.g., for a subsequent step) to ultimately provide significant benefits to consumers and producers.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method comprising:
acquiring general consumer data;
acquiring direct consumer data;
processing the general consumer data and the direct consumer data using machine learning;
providing an advertisement or commercial opportunity to a user device based on the machine learning;
determining a geographic location of the user device; and
updating the advertisement or commercial opportunity on the user device based on the geographic location of the user device.

2. The method of claim 1 wherein the general consumer data comprises geo-coded information, manufacturer information, and household information.

3. The method of claim 1 wherein the direct consumer data is acquired from mobile phones and point-of-sale devices.

4. The method of claim 1 wherein the direct consumer data is anonymized.

5. The method of claim 1 wherein the machine learning trains using the general consumer data and the direct consumer data.

6. The method of claim 1 further comprising providing analytics and visualizations to optimize retail media network profit pools.

7. The method of claim 1 wherein determining the geographic location of the user device includes utilizing near-field communication to communicate with the user device to determine how close to an exit of a store the user device is.

8. An apparatus comprising:
a non-transitory memory for storing an application, the application for:
acquiring general consumer data;
acquiring direct consumer data;
processing the general consumer data and the direct consumer data using machine learning;
providing an advertisement or commercial opportunity to a user device based on the machine learning;
determining a geographic location of the user device; and
updating the advertisement or commercial opportunity on the user device based on the geographic location of the user device; and
a processor coupled to the memory, the processor configured for processing the application.

9. The apparatus of claim 8 wherein the general consumer data comprises geo-coded information, manufacturer information, and household information.

10. The apparatus of claim 8 wherein the direct consumer data is acquired from mobile phones and point-of-sale devices.

11. The apparatus of claim 8 wherein the direct consumer data is anonymized.

12. The apparatus of claim 8 wherein the machine learning trains using the general consumer data and the direct consumer data.

13. The apparatus of claim 8 wherein the application is further configured for providing analytics and visualizations to optimize retail media network profit pools.

14. The apparatus of claim 8 wherein determining the geographic location of the user device includes utilizing near-field communication to communicate with the user device to determine how close to an exit of a store the user device is.

15. A system comprising:
one or more servers configured for:
receiving general consumer data and direct consumer data; and
processing the general consumer data and the direct consumer data using machine learning;
a mobile device configured for:
acquiring direct consumer data and sending the direct consumer data;
receiving an advertisement or commercial opportunity based on the machine learning;
providing a geographic location to the one or more servers; and
updating the advertisement or commercial opportunity on the user device based on the geographic location of the mobile device; and
one or more sensor devices for communicating with the mobile device regarding the geographic location of the mobile device.

16. The system of claim 15 wherein the general consumer data comprises geo-coded information, manufacturer information, and household information.

17. The system of claim 15 wherein the direct consumer data is acquired from mobile phones and point-of-sale devices.

18. The system of claim 15 wherein the direct consumer data is anonymized.

19. The system of claim 15 wherein the machine learning trains using the general consumer data and the direct consumer data.

20. The system of claim 15 wherein the one or more servers are further configured for providing analytics and visualizations to optimize retail media network profit pools.

21. The system of claim 15 wherein determining the geographic location of the user device includes utilizing near-field communication to communicate with the user device to determine how close to an exit of a store the user device is.
